(19) United States
(12) Patent Application Publication
(10) Pub. No.: US 2013/0010464 A1
(43) Pub. Date: Jan. 10, 2013

(54) HIGH INTENSITY LIGHTING FIXTURE

(75) Inventors: Ahmed Shuja, San Francisco, CA (US); Tom Griffin, San Ramon, CA (US); Ron Van Thiel, Menlo Park, CA (US); Phil Craine, Saratoga, CA (US); Praveen Medis, Moraga, CA (US)

(73) Assignee: BritePointe, Inc., Hayward, CA (US)

(21) Appl. No.: 13/420,498

(22) Filed: Mar. 14, 2012

Related U.S. Application Data
(60) Provisional application No. 61/505,419, filed on Jul. 7, 2011.
(60) Provisional application No. 61/561,814, filed on Nov. 18, 2011.

(51) Int. Cl. F21V 29/00; F21V 7/00

(52) U.S. Cl. 362/235; 362/249.02

(57) ABSTRACT

A high intensity lamp is described herein. The lamp comprises a LED array emitting a light and a two-phase cooling apparatus. The LED array includes a plurality of LEDs. The LEDs are arranged in close proximity so that a luminous emittance from a emitter area of the LED array is at least 1000 lumens per square centimeter. The two-phase cooling apparatus is thermally coupled to the LED array. A lumen-to-weight metric of the device is at least 4000 lumens per kilogram

### PRIORITY CLAIM

This application claims priority to U.S. Provisional Patent Application No. 61/505,419, entitled “LED High Bay Lighting”, which was filed on Jul. 7, 2011, and U.S. Provisional Patent Application No. 61/561,814, entitled “High Intensity Indoor Lighting Fixtures”, which was filed on Nov. 8, 2011, the contents of which are expressly incorporated by reference herein.

### HELD OF THE INVENTION

The present invention relates to a lighting fixture and more particularly, to a high intensity LED lighting fixture for high bay lighting application.

### BACKGROUND

General lighting consumes 20% of the electricity used globally each year. When looking specifically at industrial lighting where high lumen output fixtures are used, High Intensity Discharge (HID) sources only account for 2% of the installed base in the US, but can consume 22-30% of the energy usage in industrial facilities. In warehouses using high bay lights, the percentage can be higher as 40-50% of the total energy usage. Currently the industrial sector alone is consuming 900 TWhr per year globally on electricity for lighting, which translates to 614 million metric tons of CO₂, roughly equivalent to what 240 million barrels of oil can produce. The importance of the opportunity to save 50% or more of the energy cannot be understated.

As the efficacy of phosphor converted LED components has steadily increased to over 100 lm/W, a unique opportunity of energy saving has arrived. 50-90% of energy usage can be saved in the industrial, warehouse, and commercial indoor lighting sector by replacing HID sources with more energy efficient lighting sources such as LED lighting. Innovation in high intensity lighting is in high demand and multiple technological approaches are being developed.

In applications where high intensity sources are required, it is desirable for the light source to appear as a point or line light source. The intensity of a light source is typically defined by the unit luminance (candela/m²). For example, the sun has a rating of 10⁹ candela/m², while high brightness source, such as HID bulb can have intensities of 10⁷ candela/m². Typically low pressure mercury sources, such as linear fluorescent lamps, have lower intensities of 10⁴ candela/m², which lead to their larger bulb sizes.

One common high intensity light source in high bay lighting, High Intensity Discharge (HID) light source, can contain rare earth metal salts termed metal halide (MH) and had been in existence for over fifty years. This MH technology, reminiscent of the vacuum tube era and is one of the applications today still utilizing vacuum tube technologies. HID light sources are widely used despite the fact that this type of light source can consume a great deal of energy. MH and other HID lamps are compact light sources that require ballasts to provide a regulated supply of electricity for starting and maintaining a constant current during bulb operation. Since the metal halide bulb was invented in the 1960's, additional improvements of the metal halide lighting have mainly centered on the ballast technology. The latest ballast improvements using digital ballasts are introduced only at end of the last century. Even with the recent ballast technology advances, adoption is slow since digital ballasts can cost up to six times more than conventional magnetic ballasts. Overall there is no indication that the MH bulb technology will see significant advances in efficacy in the coming years. Also the HID/MH lamps and their arc tubes operate at extremely high temperatures and can shatter if precautions are not taken. Also related to building energy efficiency, the MH bulbs can act as radiant heaters heating the surrounding air, and this heat must be extracted by HVAC, which raises energy consumption. MH bulbs typically burn out every 10-12 thousand hours, which force building owners to replace millions of metal halide bulbs annually.

Solid state lighting (SSL) has begun to emerge and is now competing with HID and MH lighting. As of today, most SSL alternatives for HID fixture replacement have still been cost prohibitive. The area of high bay lighting to date has seen modest penetration (i.e. <1%) by LED luminaries that are direct fixture replacements of metal halide fixtures. The current products are getting more competitive and are now only 3-5 times more expensive than the existing metal halide fixture. The market tipping point may have arrived. One issue with LED high bay fixture replacement to date is how to recreate radiation patterns and illumination levels that mimic the existing MH fixtures. Due to the need of thermal dissipation, the LED luminaries typically have large area metal core printed circuit boards where each LED is spaced several centimeters apart. The large lumen output of high bay lighting may require tens or hundreds of LEDs. This complicates optical design and how to most effectively design LED luminaries that can recreate comparable color temperature, light distribution and light intensity so that preexisting building electrical grids can be preserved. The optical output of LEDs in general illumination is reduced by current droop, elevated junction temperature, and fixture loss. Due to these losses, a large number of LEDs are needed resulting in cost increases. To produce greater than fifteen thousand lumens, a typical existing LED luminaire can cost five times more than typical MH fixtures.

Alternative lamp sources, other than LED, have begun to make in-roads in the market for high bay lighting. The most successful competing technology is the Linear Florescent Lamps (LFL) in the form of super T8 and T5 bulbs that have been introduced to high bay lighting. The LFL is a low pressure mercury gas discharge lamp that will typically contain 2 mg of mercury in each bulb. During operation, the mercury in the bulb is ionized into a plasma. The fluorescent fixtures typically require six times the maintenance cost of a metal halide fixture because there is a 6:1 ratio between the light outputs of HID bulbs and LFL. Another drawback to this approach is that the LFL fixtures will have different spacing criterion than the HID so the lighting grid will need to be changed. It is anticipated that the fluorescent technologies are an intermediate step to the eventual adoption of SSL. Other alternatives to the MH also include High Pressure Sodium (HPS) and Low Pressure Sodium (LPS), but these lamp sources have begun to be phased out due to limited lifetime, poor CRI and expensive bulb replacement.

Another variant of low pressure mercury lamp is the Induction Fluorescent lighting (IFL) that removes the electrode from the bulb. Without the electrodes, the bulb life of IFL is significantly extended. In this approach, high frequency energy from the ballast, is sent through wires, which are wrapped in a coil around the ferrite inductor on the outside of the glass tube, creating a powerful magnet. The inductive coupling of a magnetic field induces an electric field in the bulb. The electric field stimulates a plasma of mercury ions that emit UV light. The UV light is then down-converted to white light by phosphors disposed on the inner surface of the lamp. One problem with this approach is that IFL having a poor fixture efficiency of 70% because the light source has lower luminance intensity of 10⁴ candela/m². The second problem is that IFL has a torus shape. These attributes cause light loss between the bulb and the reflector. This light loss in the fixture causes the lux level on the floor to be lower than required in some applications. Also the ballast of the IFL is multistage to transform from AC to DC and then to high frequency DC at 2.65-13.65 MHz. This multistage system's efficiency is less than 90%. The power conversion inefficiency leads to waste heat and must be cooled leading to the use of cast aluminum heat sinks for proper thermal management. This can increase the weight of the lighting system which is undesirable in high bay lighting application.

An even newer approach of Light Emitting Plasma (LEP) has been developed for indoor high bay lighting. In this approach a radio frequency (RF) signal is generated by a solid-state RF driver. The signal is applied to a waveguide that houses an evacuated glass envelope. The contents of the bulb are excited to a light emitting plasma by this concentrated electromagnetic field. This technology generates more than 15,000 lumens with a very small glass envelope and without the use of mercury. However, similar to the IFL, the LEP requires a multistage power supply to go from AC-DC and subsequently a RF driver. A another shortfall of this approach is the difference in beam pattern shape when compared to MH. Also this fixture can be quite heavy due to the heat sinking requirements of the multi-stage ballast components.

It is desirable to have a LED lighting fixture that has a high lumen intensity while still maintains a weight suitable for high bay lighting application.

The foregoing examples of the related art and limitations related therewith are tended to be illustrative and not exclusive. Other limitations of the related art will become apparent upon a reading of the specification and a study of the drawings.

### SUMMARY

Introduced herein is a high intensity lamp. According to one embodiment, there is provided a lamp comprising a LED array emitting a light and a two-phase cooling apparatus. The LED array includes a plurality of LEDs. The LEDs are arranged in close proximity so that a luminous emittance from an emitter area of the LED array is at least 1000 lumens per square centimeter. The two-phase cooling apparatus is thermally coupled to the LED array. A lumen-to-weight metric of the device is at least 4000 lumens per kilogram

In a related embodiment, a lumen-to-weight metric of the lamp is at least 4000 lumens per kilogram. In another related embodiment, the two-phase cooling apparatus includes a condenser coil and a plurality of heat dissipation fins thermally coupled to the condenser coil. The fins sit vertically. In yet another related embodiment, the two-phase cooling apparatus further includes an evaporator thermally coupled to the LED array, and the evaporator hydraulically coupled to the condenser coil. In still another related embodiment, the evaporator contains a fluid and a wick structure, and the wick structure operates as a capillary pump of the fluid.

In another related embodiment, the lamp further comprises a power supply electrically coupled to the LED array, and the power supply is operating to rectify an incoming AC current into a DC current to power the LED array. In yet another related embodiment, the lamp further comprises a housing having a plurality of air vents. In still another related embodiment, an emitting direction of the LED array is down card, and the lamp further comprises a secondary optic optically coupled the LED array to modify a beam pattern of the light emitted from the LED array. In yet still another related embodiment, the lamp further comprises a reflector to direct a portion of the light emitted from the LED array upward, and at least a portion of the reflector is transparent or translucent.

In another related embodiment, the LEDs are configured so that a total luminous flux of the lamp is at least 15000 lumens. In yet another related embodiment, the light emitted from the LED array has a color rendering index of at least 70. In still another related embodiment, an expected lifetime of the lamp is at least 50000 hours. In yet still another related embodiment, a beam angle of the lamp is at least 120 degrees.

In another related embodiment, the two-phase cooling apparatus includes: a first layer which mounts the light-emitting device and channels vapor along a heat transfer region; a liquid-permeable porous structure, coupled to the first layer, which transports vapor to a vapor line, wherein the vapor is generated at a liquid menis s of the liquid-permeable porous structure at a phase change temperature; a second layer, hydraulically coupled to the liquid-permeable porous structure, which contains liquid below a phase change temperature; and a condenser, coupled to the second layer, by which vapor condenses to liquid and returns to the second layer. In yet another related embodiment, the two-phase cooling apparatus further includes a vapor port coupled to the condenser, and the vapor port is substantially unobstructed to allow the generated vapor to exit. In still another related embodiment, the two-phase cooling apparatus further includes a chamber thermally coupled to the LED array, and heat generated from the LED array is absorbed by a liquid stored in the chamber.

This Summary is provided to introduce a selection of concepts in a simplified form that are further described below in the Detailed Description. This Summary is not intended to identify key features or essential features of the claimed subject matter, not is it intended to be used to limit the scope of the claimed subject matter.

### BRIEF DESCRIPTION OF THE DRAWINGS

One or more embodiments of the present invention are illustrated by way of example and are not limited by the figures of the accompanying drawings, in which like references indicate similar elements.

FIG. 1 illustrates an example of a LED luminaire.

FIG. 2A illustrates a cross sectional view of an example of a LED luminaire.

FIG. 2B illustrates a self cleaning feature of a luminaire.

FIG. 3 illustrates a cross sectional view of a central portion of a LED luminaire.

FIG. 4 illustrates beam patterns of a LED luminaire and a metal halide HID lamp.

FIG. 5 is a bar diagram comparing lumen-to-weight metrics of various lighting fixtures.

FIG. 6 is a diagram illustrating relative manufacturing cost for components of LED luminaires over different time periods.

FIG. 7A illustrates an example of a LED luminaire connected to an existing HID base.

FIG. 7B illustrates another example of a LED luminaire connected to an existing HID base.

### DETAILED DESCRIPTION

Various aspects of the invention will now be described. The following description provides specific details for a thorough understanding and enabling description of these examples. One skilled in the art will understand, however, that the invention may be practiced without many of these details. Additionally, some well-known structures or functions may not be shown or described in detail, so as to avoid unnecessarily obscuring the relevant description. Although the diagrams depict components as functionally separate, such depiction is merely for illustrative purposes. It will be apparent to those skilled in the art that the components portrayed in this figure may be arbitrarily combined or divided into separate components.

The terminology used in the description presented below is intended to be interpreted in its broadest reasonable manner, even though it is being used in conjunction with a detailed description of certain specific examples of the invention. Certain terms y even be emphasized below; however, any terminology intended to be interpreted in any restricted manner will be overtly and specifically defined as such in this Detailed Description section.

References in this specification to “an embodiment,” “one embodiment,” or the like mean that the particular feature, structure, or characteristic being described is included in at least one embodiment of the present invention. Occurrences of such phrases in this specification do not necessarily all refer to the same embodiment.

According to the present invention, a new class of LED lighting called extreme brightness is introduced and a fixture according to one embodiment called the HyBeem (a registered trademark of BritePointe Inc) is disclosed. Some similar techniques related to this application are discussed U.S. Patent Publication No. 2011/0043092 A1, titled “LED Bulb for High Intensity Discharge Bulb Replacement” and U.S. Patent Publication No. 2010/0038660 A1, titled “Two-Phase Cooling for Light-Emitting Devices”, the contents of which are expressly incorporated by reference herein. Within the disclosure, the definition of extreme brightness is the ability to create an illuminance of 1000 lm/cm² or 10,000 lm/in² from a LED array board. The ability to create a very high luminance, as high as 318 candela/cm², which mimics a point source, is ideal for many lighting applications. In indoor lighting small sources are preferred because the secondary operation of shaping the light is made easier and less light is lost. This type of LED modules that produce tens of thousands of lumens could be widely applicable to street lighting, high bay lighting, or even automotive lighting. The extreme brightness LED light modules must be complemented with a high performance thermal management systems that can keep the LED dies well below the maximum junction temperature and allow fixture lifetimes of greater than 50,000 hours with less than 30% light reduction. This disclosure details this approach and demonstrates an application of an indoor high bay fixture that is made possible by the approach.

In industrial and commercial applications where HID/MH replacements occur, the electrical grid and the necessary floor lighting pattern pre-exists and is expensive to alter. Consequently, in order to provide a LED fixture, the light source needs to produce similar lumen output and similar illumination pattern on the floor. If the LED light source can be made into a dense array, then simple secondary optics made of glass or acrylic can be used to shape the light to match previous metal halide light distribution. By grouping many high intensity LED sources in close proximity, an extreme brightness source of 1000 lumens per square centimeter is possible. With extreme brightness arrays, modular systems utilizing LED sources can achieve different beam distribution diameters and shapes.

A typical high bay light based on metal halide technology consumes 400 W of power and will produce 15,000-20,000 lumens after some initial hours of burning in. This lumen output is necessary for the right illumination level at a work surface, which is typically 30-300 lux (3-30 footcandle) depending on mounting height. Thus for a LED lamp with a fixture efficacy of 80-100 lm/W, a typical thermal heat flux could range from 150-250 W. This thermal energy comes in the form of phonons moving through a semiconductor lattice and will thermally conduct through the soldered side of the LED package. In LED lamps, nearly 100% of the waste heat is released by solid conduction. When replacing HID sources with LED based sources, it is common for the LED source to only require half the wall plug power for the equivalent lumen output. In general HID source can provide the same 80-100 lm/W bulb efficacy but the fixture losses are typically greater making the luminaire less energy efficient. With a HID source such as MH, the waste heat energy (˜90% of the energy) is released by electromagnetic radiation so no conduction cooling is needed at the bulb.

When employing a LED fixture replacement for high bay, fans are not typically permitted due to reliability and noise concerns. For any semiconductor thermal management application, when greater than 100 W of thermal energy needs be released without assisted convective cooling, a typical heat sink needs to weight several kilograms. For example, for LED fixtures currently on the market, if 200 W of thermal power needs be dissipated, the heat sink alone can weigh about 18 Kg (40 lbs).

The Loop Heat Pipe (LHP) is a two-phase heat-transfer device with capillary pumping of the working fluid that is utilized in the HyBeem for them al control of extreme brightness LED arrays. The LHP device includes an evaporator, a condensation heat exchanger which guides vapor and liquid flow. In operation, the liquid medium is converted to vapor at the evaporator and is then converted back to a liquid at the condenser so that the heat at the evaporator is mostly converted into latent heat of phase transformation and is dumped at the condenser by the reverse process in an essentially adiabatic process. The pressure of vaporization is larger than the pressure of condensation, and hence the vapor flows from the evaporator to the condenser with no additional power input. Consequently, the LHP is passive in that it operates on waste heat. This passive transport of a working fluid is achieved by capillary pumping of a wick structure, which is located in the evaporator. The wick can act as the “engine” in the LHP as long as the external pressure drop in the loop does not exceed the internal pressure drop across the wick structure suiting from the wetting hydrophilic nature of the interior of the wick surface causing a meniscus film across the wick structure). The entire cycle of evaporation and condensation occurs in this sealed, evacuated loop.

The flat evaporator architecture of LHP is created to quickly integrate with extreme brightness LED modules. The attachment is made with a thermal interface material between a metal core board and the evaporator packaging plane. This quickly reconfigurable connection is both low thermal resistance and different type of LED boards can be married to a single thermal management platform.

The use of two-phase cooling in the form of heat pipe, thermosyphons, capillary pumped bops, vapor chambers, or bop heat pipes to thermally stabilize extreme brightness LED arrays has the advantage of lower weight or mass fixtures. This mass savings of weight occurs from replacing the mechanism of heat transport from the LED metal core printed circuit board (MCPCB) to ambient air from solid conduction to two phase convection. This heat flow technique allows subtraction of the large amounts of metal heat sinking components.

It has become more common in the durable goods industry to look more heavily at the cradle to the grave life of products to measure complete sustainability. If this is the case then ideally products that are made more environmentally friendly will see greater market penetration and success. With the extreme brightness design approach the ability to use recycled plastic content for lighting fixtures and to subsequently recycle the major components of HyBeem lighting fixture could be made possible. Besides having a better cradle to the grave life cycle, the LED based products do not require mercury disposal.

As the LED dies become cheaper, it is desirable that the amount of metallic materials used in construction of fixtures decreases as well to further reduce the construction cost. In order to quantify this, a new lumen-to-weight metric with a unit of lumens per kilogram (lm/Kg) is introduced. The lumen-to-weight metric is defined as the lumen output (luminous flux) of the fixture at steady state being divided by the mass (also commonly referred to as weight, in everyday practical usage, including commercial usage) of the fixture. The mass includes all mass of driver/ballast components, reflectors, and mounting assemblies. When this metric is calculated for various existing lighting SSL, LFL, MH, LPS, HPS, IFL,and LEP technologies it is found that achieving greater than 2500 lm/Kg is challenging utilizing current state of the art technology. The present invention moves the state of the art beyond the 2500 lm/Kg.

A common overlooked characteristic of the SSL products are environmental issues that can artificially age the lighting products. This is quite pronounced in high intensity lighting applications due to the heat sink being perpendicular to the gravity direction. In most current SSL fixtures the aluminum heat sink in opposition to the LED array and is mechanically connected for direct conduction cooling. This causes complication of dust fouling during the off cycle which can be 4-9 hours daily in many applications. This dust build up will reduce the convection coefficient and cause the junction temperature to drift upward. This results in faster lumen degradation and color shift. This is commonly overlooked since the light degradation is measured by using LED component data that are ran in a closed environmental system. The present invention addresses the problem of dust fouling.

In general lighting, common metrics used to qualify a lighting product include the correlated color temperature (CCT) of the light and the color rendering index (CRI). These metrics are mainly dominated by the luminaire manufactures choice of LEDs that are used to form the LED array board. For high intensity lighting, color temperatures are generally in the range of 3500K-6000K and the CRI is desired to be above 70.

Embodiments of the present disclosure include configurations that enable LED lighting fixtures that can be employed in lighting applications where ceiling heights exceed 5.5 meters in height.

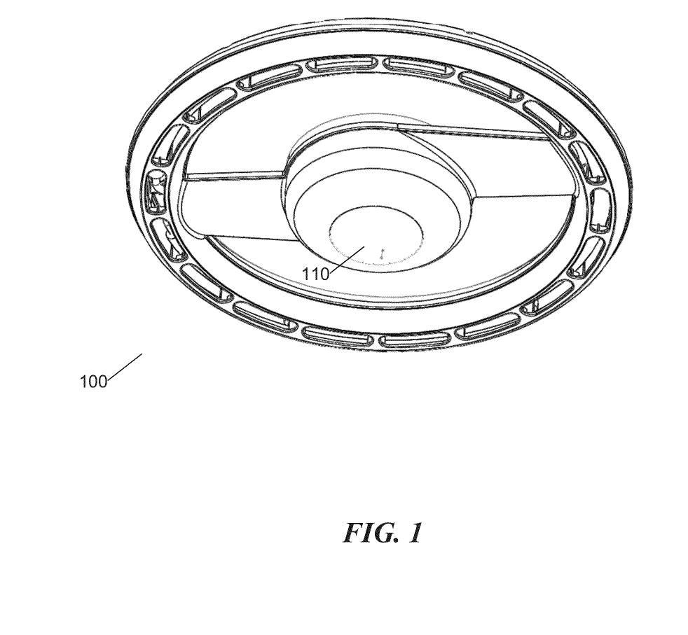

FIG. 1 illustrates the LED luminaire 100 having an extreme brightness source capable of emitting 15,000 lumens or greater from the fixture. In the current embodiment the LED module sits behind the lens 110 and making it necessary for the source to emit greater than 16,500 lumens to compensate for fixture loss. Given the square area of the source typically ranging from 15-18 cm² the source should be capable of emitting 900-1000 lm/cm ² or greater than 318 candela/cm².

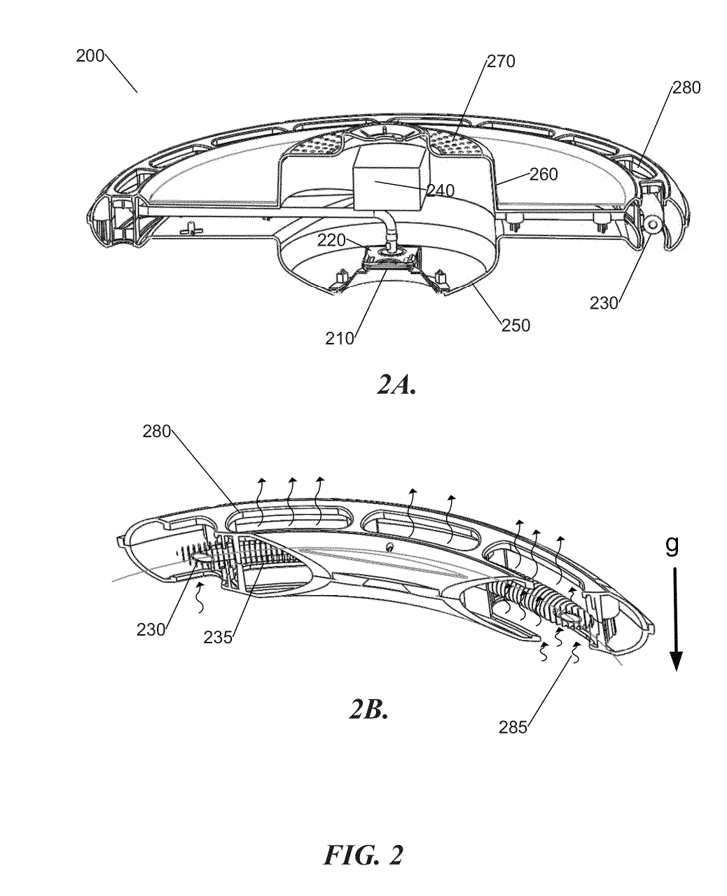

FIG. 2A illustrates a cross sectional view of the LED luminaire 200. The LED array 210, as an extreme brightness light source, is mounted to the evaporator 220 of the loop heat pipe such that the heat is transferred from the LED module into vapor within the cooling system. The LED array groups a plurality of high intensity LEDs in close proximity, the luminous emittance from the emitter area is at least 1000 lumens per square centimeter. The emitter area is defined as the area occupied by the LED array, including the area of the LEDs and the area between the LEDs. The vapor is condensed in a condenser coil 230 which spirals upward from the evaporator and forming a halo like circular shape of about 0.6 meters in diameter. The LED array is driven by a power supply 240 that sits within the fixture housing. This power supply acts to rectify the incoming AC current and establish a constant current DC drive to power the LED array. The power supply 240 can be of the dimming type so that the light output can be adjusted below 100% output. The optical, thereto-mechanical, and electrical components are housed in between the bottom housing 250 and the top housing 260 which are held together by screws or rivets. The housing is injection molded from lightweight plastic and includes appropriate air vents for natural convection cooling. The air vents 270 are positioned such that the power supply 240 will be capable of releasing waste heat that comes from the power conversion. The evaporator 220 and the power supply 240 must be positioned not too close in proximity so that they do not communicate thermally. Another series of air vents 280 are positioned at the periphery of the housing such that they align with the coil 230 as to allow airflow.

FIG. 2B illustrates a self cleaning feature of the luminaire. During operation, the heat is transferred to the condenser coil by way of vapor that condenses along the interior surface of the coil which can deliver heat with very little temperature drop. The coil 230 may have fins 235 oriented in a vertical direction or parallel to the gravity vector. In operation, the airflow 285 will enter from the bottom of the housing. The air receives heat from the outer surface of the coil 230 and expands, resulting in a rise in volume flow rate. This increase in volume flow rate decreases the convection boundary layer thickness around the fins 235 and thus promotes the heat transfer. This effect is utilized between the air vents 280 to increase the effectiveness of heat transfer. In addition, this airflow increase makes dust difficult to settle on the coil during operation, increasing the lamp reliability. In LED lights, if dust settles on the heat sink, the convection heat transfer is hindered and increases the LED junction temperature. In the existing high intensity LED lights for high bay, the heat sink is typically cast aluminum and the surface is perpendicular to the gravity vector with the fins protruding up parallel to the gravity vector. This occurs because the heat is removed by direct thermal conduction from the LED to MCPCB to the heat sink on the opposing side. A horizontal oriented heat sink will cause the junction temperature of the LED to drift upward over time as dust settles, thus resulting in more rapid lumen degradation. By utilizing the disclosed remote heat exchanger coil that reduces the area perpendicular to gravity vector, this issue has been solved. In addition to this benefit, by having a coil 230 that utilizes two-phase for heat transport, the heat is delivered to the convection surface with less temperature difference which allows for the overall area of the heat exchanger to be less than the area needed for a heat sink by half. Consequently, the convection coefficient is increased, which can be numerically estimated by the Grashopf or Raleigh non-dimensional numbers.

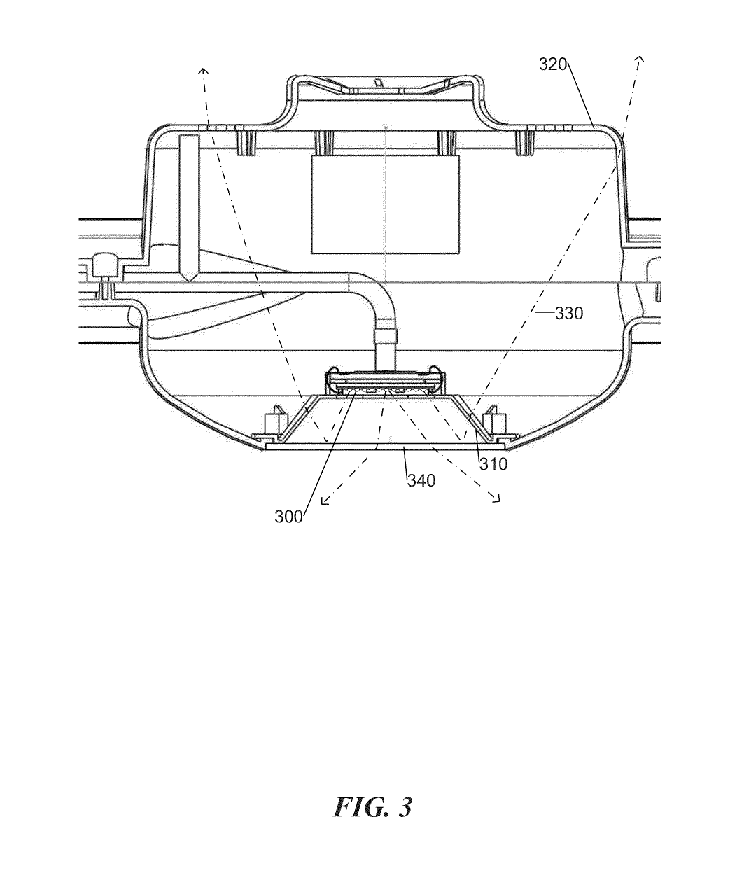

FIG. 3 illustrates a cross sectional view of the central portion of the LED luminaire. The LED luminaire includes optical features for creating up-light with a downward facing extreme brightness LED source 300. By creating light at an intensity of 1000 lm/cm² coupled to a two phase cooling mechanism, the source can be small in square area. Commonly surface mount LEDs are offered that have beam angles of 120 degrees, allowing for rather wide beam angles. The reflector 310 may injection molded and at least a portion contains a transparent or translucent plastic. Also the top housing 320 may be formed of a transparent or translucent plastic or colored plastic. As the light rays 330 scatter from the secondary lens 340, they can pass through the reflector 310 and finally pass through the top housing 320. In high bay lighting application such as big box retail, there is a desire to have some light illuminating the ceiling or a colored light illuminating the ceiling. This small percentage of the total source lumens, typically on the order of 7-10%, keeps the indoor environment from visually appearing like a cave, where the ceiling is dark without the lighting. It is hard to achieve this for existing LED fixtures whose LEDs are mounted to a large metallic heat sink, wherein the metallic heat sink can not be made opaque. This makes most solid state lights undesirable for application where up-light is required. The fixture as shown in FIG. 3 allows for 7-10% of up-light by utilizing a transparent or translucent plastic for parts 310 and 320. The light reflected up could also be tinted a color by varying the translucent color of part 320.

The LED light emitter may be a compact light source having illuminance of greater than 1000 lm/cm². If the reflector 310 is made of white opaque plastic, the fixture lumen loss is typically less than 10%. The fixture lumen loss primarily is determined by the surface finish and transmission characteristics of the secondary optic lens 340 and the reflectivity of 310. The secondary optic lens 340 can have many lens variations and materials. Variations include roughening, changes in focal length, scalloping etc. to allow for beam condensing or diffusing.

In another embodiment of the present invention, the secondary lens 340 can be formed with phosphor coatings to allow for down conversion of light emitted from the extreme brightness array 300. This allow for variation of the spectral power distributions of light by only changing the lens 340. This can aid with the ill effects of phosphor thermal quenching by removing the phosphor coating to a remote location where it is not in direct thermal contact with the LED die.

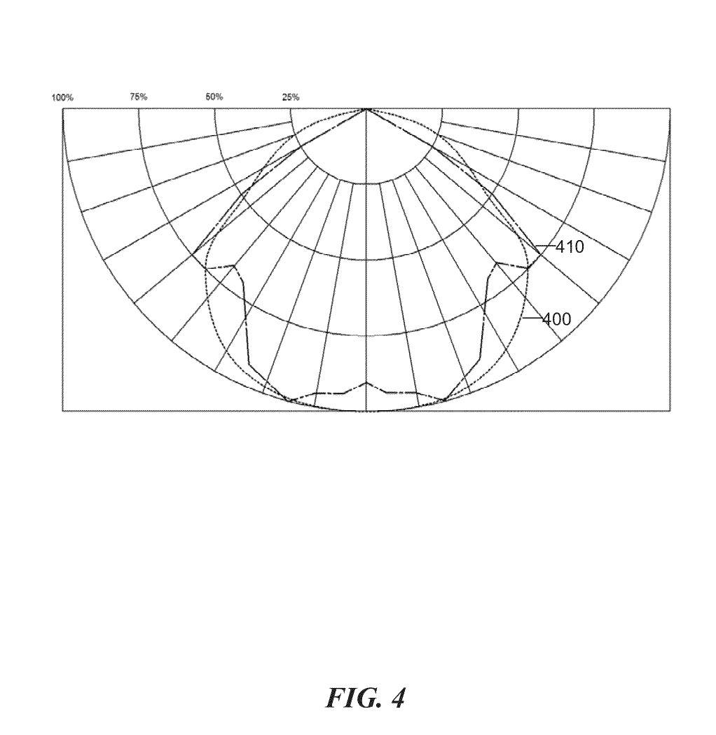

FIG. 4 illustrates a polar plot showing the disclosed a disclosed LED fixture's polar pattern 400 compared to a 400 W metal halide HID beam pattern 410. In the polar plot, the solid lines emanating radially outward from the center are laid out in 10 degree increments. The percentage shown along the top left represents the percentage of total light reduction as one moves radially away from the LED source position at zero degree. The disclosed LED fixture's light output 410 shows a very smooth light distribution which is nearly lambertian in nature. The HID source shows artifacts that typically are relevant arc length, shape of the inner glass envelope and the internal components within the HID metal halide bulb. This ability for the disclosed high intensity LED fixture to create a similar beam pattern to HID sources allows for the spacing criterion to be the same. This makes the LED fixture a one to one replacement.

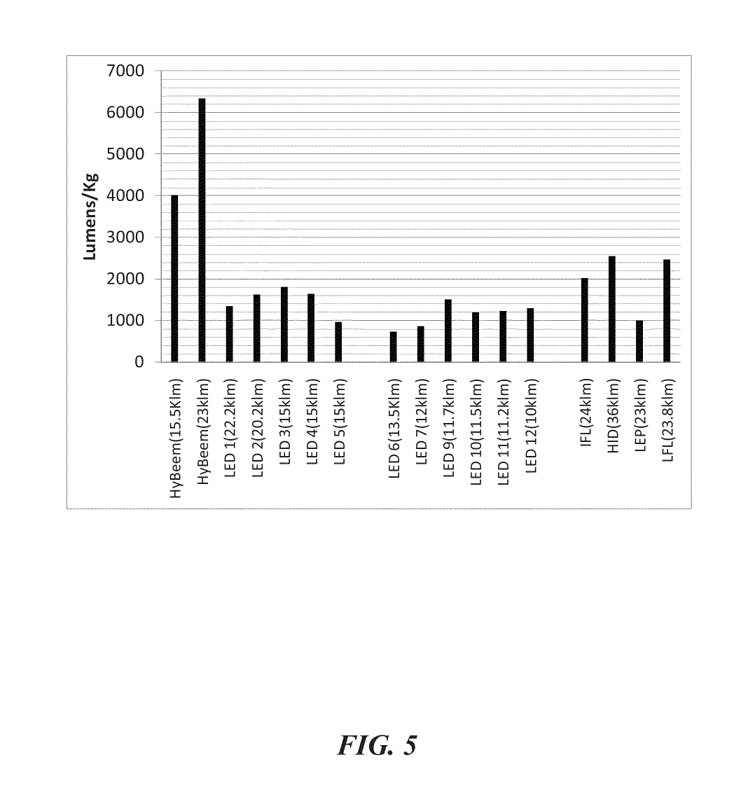

FIG. 5 illustrates the ability of the HyBeem lighting system to create a lumen-to-weight metric of greater than 4000 lm/kg which is well above any other high intensity LED fixture. A survey was conducted in 2011 to show the lumen per kilogram performance for many commercially offered LED and other high intensity sources. The data is arranged into a category of LED lamps into a greater than 15,000 lumen and one below 15,000 lumens. To further demonstrate how the HyBeem design compares to the other lighting technologies, there is a third category for IFL, HID, LEP and LFL as well. For the LFL technology, a 6 bulb T5 HO fixture is used to show the most promising LFL for achieving above 2500 lm/Kg. The low weight advantage in this fixture type is offset by the continued need for the use of mercury which is typically 1.8 mg of mercury per T5 HO bulb. So if one to three fixtures are required to replace one metal halide fixture then the mercury content can be above 30 mg of Hg per bulb change cycle. The typical 400 W metal halide bulb contains 50-80 mg of Hg but requires only one bulb change compared to 6-18 for the LFL case. In the best case scenario for high intensity lighting where no mercury is utilized, the LED and LEP technologies are the candidates. In this case the LED lamps seem to provide higher lumen per kilogram performance than the LEP. The energy conversion losses usually manifest as heat, the traditional design route is to utilize heat sinks to dissipate this waste heat. With the use of two phase cooling in LED lamps this ratio can be increased to 4000 lm/kg or greater.

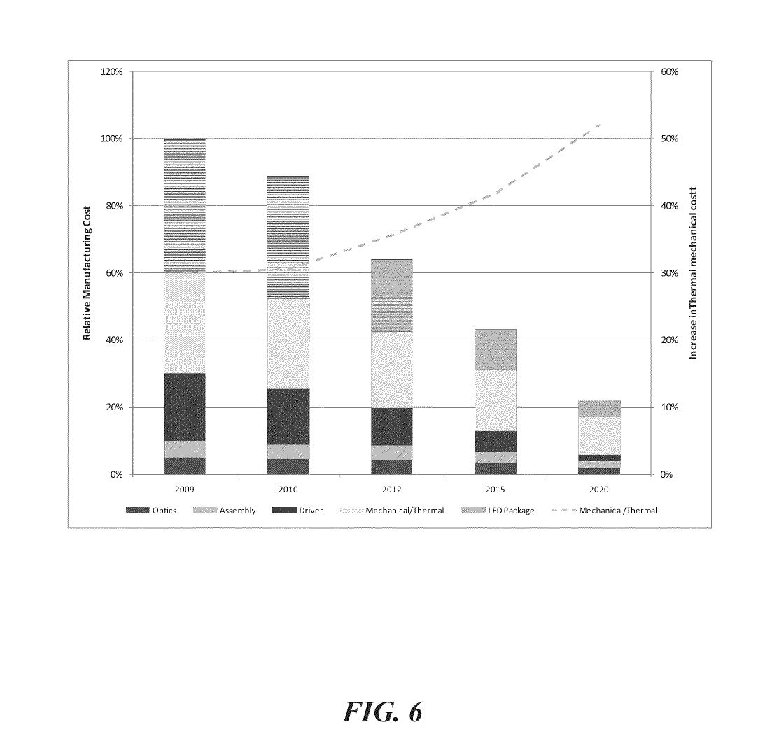

FIG. 6 illustrates finished goods cost structure for creating LED luminaries and how it has varied historically and projected to vary up to 2020. As the cost of the LED components drops dramatically, the ability to reduce the cost of the mechanical/thermal components becomes the determining factor in the finished goods cost structure. It has been predicted that by 2020 the mechanical/thermal components will be 50% or greater of the total finished goods cost. This will have two effects on the market. As the LED efficacy continues to increase it will take less power to make high lumen output lamps. Thus optimizing LED luminaire design for best lm/kg performance is a means of optimizing for the lowest finished goods cost. Thus at the lighting market, lamps with the lowest first cost to customers i.e. best lm/kg performance, ends up with the largest market share.

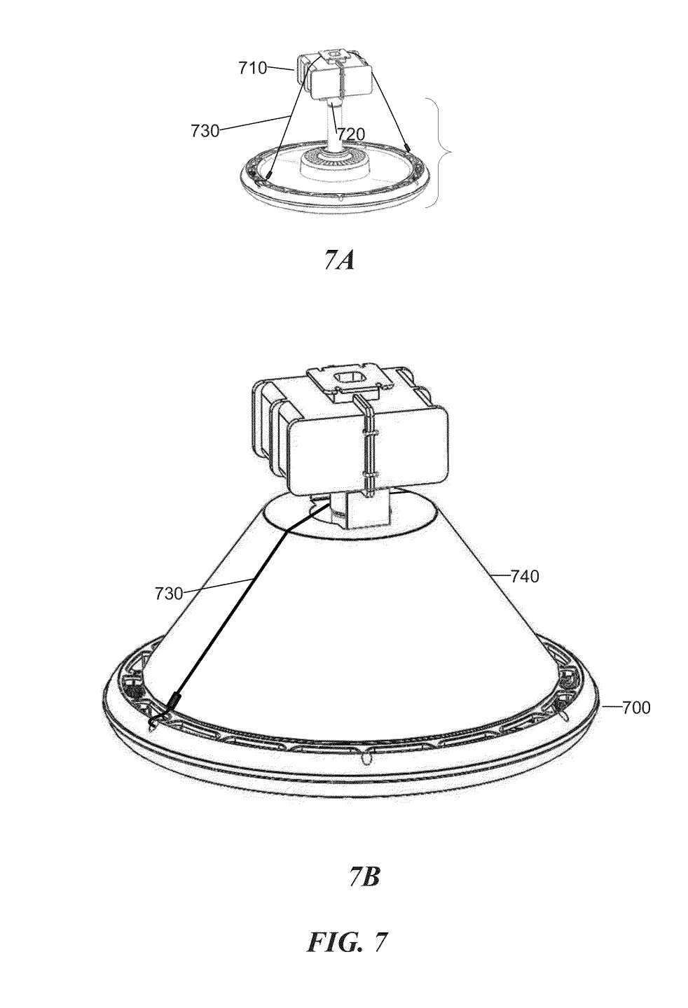

FIG. 7A illustrates another feature of the disclosed fixture. With small hardware components, the fixture can be utilized as a retro-fit kit for existing metal alide installations. The HyBeem integrated LED fixture may be attached to an existing HID ballast by rotating the system into a mogul base connection. In the scenario, the efficiency increases by bypassing the original ballast. In order to reduce the weight impose on the mogul base a braided steel cable 730 is connected to the HyBeem integrated LED lamp. This lowers the weight that is experienced by the mogul base to below 3.75 pounds or 1.7 kg. Thus the mogul base is less likely to experience brittle failure due to tensile strain.

FIG. 7B illustrates a HID fixture with the HyBeem retrofit system 700, in which the original reflector 740 of the HID fixture is still installede. A typical issue with traditional LED retrofit lamps is the increased fixture loss due to the LED retrofit using the original installed optics. With the current embodiment, the HID optic is not used so the fixture loss is less than 10%. Typically the HID fixtures have reflectors ranging in size from 40-55 cm (16″-22″) in diameter. The LED luminaire retrofit kit 700 was design to allow the heat exchanger coil will always sit outside the reflector 740 even at the largest original size. In the install case here the air craft cable 730 is being supported by the reflector 740 to reduce the weight on the E39 mogul base.

Unless the context clearly requires otherwise, throughout the description and the claims, the words “comprise,” “comprising,” and the like are to be construed in an inclusive sense, as opposed to an exclusive or exhaustive sense: that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶6, other aspects may likewise be embodied as a means-plus-function claim, or in other forms, such as being embodied in a computer-readable medium. (Any claims intended to be treated under 35 U.S.C. §112, ¶6 will begin with the words “means for”.) Accordingly, the applicant reserves the right to add additional claims after filing the application to pursue such additional claim forms for other aspects of the disclosure.

1. A device, comprising:
an LED array emitting a light, the LED array including a plurality of LEDs, the LEDs are arranged in close proximity so that a luminous emittance from an emitter area of the LED array is at least 1000 lumens per square centimeter; and
a two-phase cooling apparatus thermally coupled to the LED array;
wherein a lumen-to-weight metric of the device is at least 4000 lumens per kilogram.

2. The device of claim 1, wherein the two-phase cooling apparatus includes:
a condenser coil; and
a plurality of heat dissipation fins thermally coupled to the condenser coil, the fins sitting vertically.

3. The device of claim 2, wherein the two-phase cooling apparatus,further includes an evaporator thermally coupled to the LED array, and the evaporator hydraulically coupled to the condenser coil.

4. The device of claim 3, wherein the evaporator contains a fluid and a wick structure, and the wick structure operates as a capillary pump for the fluid.

5. The device of claim 1, further comprising a power supply electrically coupled to the LED array, the power supply being operating to rectify an incoming. AC current into a DC current to power the LED array.

6. The device of claim 1, further comprising a housing having a plurality of air vents.

7. The device of claim 1, wherein an emitting direction of the LED array is downward, further comprising a secondary optic optically coupled the LED array to modify a beam pattern of the light emitted from the LED array.

8. The device of claim 7, further comprising a reflector to direct a portion of the light emitted from the LED array upward, at least a portion of the reflector being transparent or translucent.

9. The device of claim 1, wherein the LEDs are configured so that a total luminous flux of the device is at least 15000 lumens.

10. The device of claim 1, wherein the light emitted from the LED array has a color rendering index of at least 70.

11. The device of claim 1, wherein an expected lifetime of the device is at least 50000 hours.

12. The device of claim 1, wherein a beam angle of the device is at least 120 degrees.

13. A device, comprising:
an LED array emitting a light, the LED array including a plurality of LEDs, the LEDs are arranged in close proximity so that a luminous emittance from an emitter area of the LED array is at least 1000 lumens per square centimeter; and
a first layer which mounts the LED array and channels vapor along a heat transfer region;
a liquid-permeable porous structure, coupled to the first layer, which transports vapor to a vapor line, wherein the vapor is generated at a liquid meniscus of the liquid-permeable porous structure at a phase change temperature;
a second layer, hydraulically coupled to the liquid-permeable porous structure, which contains liquid below a phase change temperature; and
a condenser, coupled to the second layer, by which vapor condenses to liquid and returns to the second layer.

14. The device of claim 13, wherein a lumen-to-weight metric of the device is at least 4000 lumens per kilogram.

15. The device of claim 13, wherein the two-phase cooling apparatus further includes a vapor port coupled to the condenser, and the vapor port is substantially unobstructed to allow the generated vapor to exit.

16. The device of claim 13, wherein the two-phase cooling apparatus further includes a chamber thermally coupled to the LED array, and heat generated from the LED array is absorbed by a liquid stored in the chamber.

17. A lamp, comprising:
an LED array emitting a light, the LED array including a plurality of LEDs, wherein the LEDs are arranged in close proximity so that a luminous emittance from an emitter area of the LED array is at least 1000 lumens per square centimeter; and
an evaporator thermally coupled to the LED array;
wherein the evaporator contains a fluid and a wick structure, and the wick structure operates as a capillary pump for the fluid.

18. The lamp of claim 17, wherein a lumen-to-weight metric of the lamp is at least 4000 lumens per kilogram.

19. The lamp of claim 17, further comprising:
a condenser hydraulically coupled to the evaporator.

20. (canceled)

21. The lamp of claim 17, wherein vapor is generated from the fluid at a liquid meniscus within the evaporator at a phase change temperature:

22. A device, comprising:
an LED array emitting a light, the LED array including a plurality of LEDs, the LEDs are arranged in close proximity so that a luminous emittance from an emitter area of the LED array is at least 1000 lumens per square centimeter; and
a first layer which mounts the LED array and channels vapor along a heat transfer region;
a liquid-permeable porous structure, coupled to the first layer, which transports vapor to a vapor line, wherein the vapor is generated at a liquid meniscus of the liquid-permeable porous structure at a phase change temperature;
a second layer, hydraulically coupled to the liquid-permeable porous structure, which contains liquid below a phase change temperature; and
a condenser, coupled to the second layer, by which vapor condenses to liquid and returns to the second layer;
wherein a lumen-to-weight metric of the device is at least 4000 lumens per kilogram.
